(19) United States
(12) Patent Application Publication
(10) Pub. No.: US 2006/0209230 A1
(43) Pub. Date: Sep. 21, 2006

(54) Double-sided liquid crystal display device

(75) Inventors: Tsung Ping Liao, Miao-Li (TW); Hsueh Tien Chang, Miao-Li (TW); Chih Yang Hsu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/384,625

(22) Filed: Mar. 20, 2006

(30) Foreign Application Priority Data
Mar. 18, 2005 (TW) 94108413

(51) Int. Cl. G02F 1/1335

(52) U.S. Cl. 349/65

(57) ABSTRACT

A double-sided LCD (200) device includes an LCD panel (201) having a main-display area (208) and a sub-display area (218). A first light guide plate (204) is disposed corresponding to the main-display area. The first light guide plate has an emitting surface facing toward the main-display area, and an incident surface adjacent to the emitting surface. A first light source (205) is arranged opposite to the incident surface of the first light guide plate. A second light guide plate (214) is disposed corresponding to the sub-display area. The second light guide plate has an emitting surface facing toward the sub-display area, and an incident surface adjacent to the emitting surface. A second light source (215) is arranged opposite to the incident surface of the second light guide plate. This configuration can decrease an overall thickness of the double-sided LCD device.

### FIELD OF THE INVENTION

The present invention relates to liquid crystal display (LCD) devices, and more particularly to an LCD device capable of double-sided displaying of images.

### GENERAL BACKGROUND

As shown in FIG. 2, a conventional double-sided LCD 100 includes a first light source 105, a first light guide plate 104, a first polarizer 103, an LCD panel 101, a second polarizer 102, a second light guide plate 114, and a second light source 115 sequentially arranged. Light beams emitted from the first light source 105 transmit through the first light guide plate 104 to illuminate a corresponding part of the LCD panel 101 for displaying images. Similarly, the second light source 115 emits light beams to illuminate the other part of the LCD panel 101 for displaying images. In FIG. 2, the LCD panel 101 is shown as having two parts, such parts generally corresponding to the respective displays provided by the double-sided LCD 100 according to illumination provided by the first light source 105 and the second light source 115.

Thus in order to achieve double-sided display, the double-sided LCD 100 needs to have the two light sources 105, 115 arranged respectively opposite to front and rear surfaces of the LCD panel 101. This increases an overall thickness of the double-sided LCD 100.

What is needed, therefore, is an LCD device that overcomes the above-described deficiencies.

### SUMMARY

A double-sided LCD device includes an LCD panel having a main-display area and a sub-display area. A first light guide plate is disposed corresponding to the main-display area. The first light guide plate has an emitting surface facing toward the main-display area, and an incident surface adjacent to the emitting surface. A first light source is arranged opposite to the incident surface of the first light guide plate. A second light guide plate is disposed corresponding to the sub-display area. The second light guide plate has an emitting surface facing toward the sub-display area, and an incident surface adjacent to the emitting surface. A second light source is arranged opposite to the incident surface of the second light guide plate.

The first and second light sources are arranged opposite to the incident surfaces of the first and second light guide plates respectively. This configuration can decrease an overall thickness of the double-sided LCD device.

Other advantages and novel features will become more apparent from the following detailed description when taken in conjunction with the accompanying drawings.

### BRIEF DESCRIPTION OF THE DRAWINGS

FIG. 1 is a schematic, abbreviated, side cross-sectional view of a double-sided LCD device according to a preferred embodiment of the present invention.

FIG. 2 is a schematic, side cross-sectional view of a conventional double-sided LCD device.

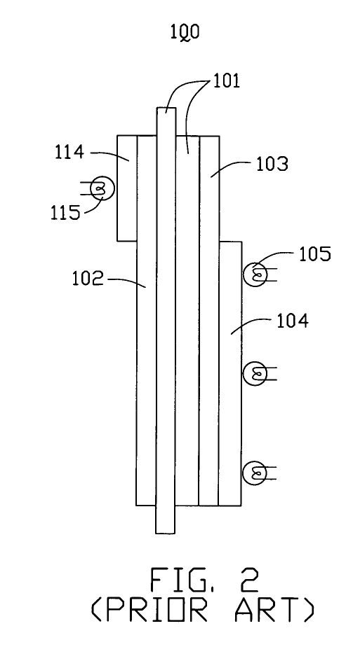

### DETAILED DESCRIPTION OF PREFERRED EMBODIMENTS

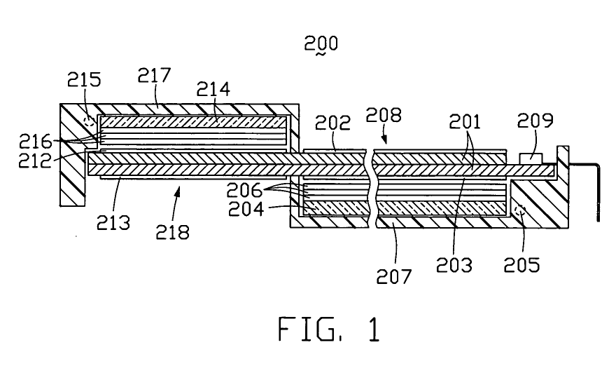

FIG. 1 is a schematic, abbreviated, side cross-sectional view of a double-sided LCD device 200 according to a preferred embodiment of the present invention. The double-sided LCD device 200 includes an LCD panel 201 (shown as generally having two parts). The LCD panel 201 includes a main-display area 208 and a sub-display area 218. Corresponding to the main-display area 208, the LCD panel 201 is provided with a first pair of polarizers 202, 203, a first light guide plate 204, and a first frame 207. The polarizers 202, 203 are adjacent opposite sides of the LCD panel 201 respectively. The first light guide plate 204 includes an edge incident surface (not labeled), and an emitting surface (not labeled) facing toward the LCD panel 201. The incident surface adjoins the emitting surface. A first light source 205 is arranged opposite to the incident surface, and a plurality of optical films 206 are sandwiched between the emitting surface and the polarizer 203.

The first light source 205 supplies light beams that eventually illuminate the main-display area 208. The first frame 207 accommodates and protects the first light guide plate 204, the first light source 205, the optical films 206, the polarizer 203, and part of the LCD panel 201 corresponding to the main-display area 208.

The structure of the sub-display area 218 is similar to that of the main-display area 208. Corresponding to the sub-display area 218, the LCD panel 201 is provided with a second pair of polarizers 212, 213, a second light guide plate 214, and a second frame 217. The polarizers 212, 213 are adjacent opposite sides of the LCD panel 201 respectively. The second light guide plate 214 includes an edge incident surface (not labeled), and an emitting surface (not labeled) facing toward the LCD panel 201. The incident surface adjoins the emitting surface. A second light source 215 is arranged opposite to the incident surface, and a plurality of optical films 216 are sandwiched between the emitting surface and the polarizer 212.

The second light source 215 supplies light beams that eventually illuminate the sub-display area 218. The second frame 217 accommodates and protects the second light guide plate 214, the second light source 215, the optical films 216, the polarizer 212, and part of the LCD panel 201 corresponding to the sub-display area 218.

The first and second light sources 205, 215 may each be one or more light emitting diodes (LEDs), or a cold cathode fluorescent lamp (CCFL).

The double-sided LCD device 200 further includes a drive IC (integrated circuit) 209 for driving the LCD panel 201. Moreover, the main-display area 208 and the sub-display area 218 may respectively display images independent from each other.

The first and second light sources 205, 215 are arranged opposite to the incident surfaces of the first and second light guide plates 204, 214 respectively. This configuration can decrease an overall thickness of the double-sided LCD device 200 compared to conventional double-sided LCD devices.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A double-sided liquid crystal display device, comprising:
a liquid crystal display panel comprising a main-display area and a sub-display area;
a first light guide plate corresponding to the main-display area, the first light guide plate having an emitting surface facing toward the main-display area and an incident surface adjacent to the emitting surface;
a first light source arranged opposite to the incident surface of the first light guide plate;
a second light guide plate corresponding to the sub-display area, the second light guide plate having an emitting surface facing toward the sub-display area and an incident surface adjacent to the emitting surface; and
a second light source arranged opposite to the incident surface of the second light guide plate.

2. The double-sided liquid crystal display device as claimed in claim 1, further comprising a drive IC (integrated circuit) for driving the liquid crystal display panel.

3. The double-sided liquid crystal display device as claimed in claim 2, wherein the main-display area and the sub-display area are configured for respectively displaying images independent from each other.

4. The double-sided liquid crystal display device as claimed in claim 1, further comprising at least one optical film sandwiched between the emitting surface of the first light guide plate and the main-display area.

5. The double-sided liquid crystal display device as claimed in claim 4, further comprising a first frame accommodating the first light guide plate, the first light source, the at least one optical film, and part of the liquid crystal display panel.

6. The double-sided liquid crystal display device as claimed in claim 1, further comprising at least one optical film sandwiched between the emitting surface of the second light guide plate and the sub-display area.

7. The double-sided liquid crystal display device as claimed in claim 6, further comprising a second frame accommodating and protecting the second light guide plate, the second light source, the at least one optical film, and part of the liquid crystal display panel.

8. The double-sided liquid crystal display device as claimed in claim 1, wherein the first and second light sources are light emitting diodes.

9. The double-sided liquid crystal display device as claimed in claim 1, wherein the first and second light sources are cold cathode fluorescent lamps.

10. A double-sided liquid crystal display device, comprising:
a liquid crystal display panel comprising a first area and a second area exposed to an exterior in opposite first and second directions and not mutually overlapped with each other in both said first and second directions;
a first light guide plate spaced from the first area in said second direction;
a first light source located beside said first light guide plate in a first lateral direction essentially perpendicular to both said first and second directions;
a second light guide plate spaced from second area in said first direction; and
a second light source located beside said second light guide plate in a second lateral direction essentially perpendicular to both said first and second directions.

11. The double-sided liquid crystal display device as claimed in claim 10, wherein said first lateral direction and said second lateral direction are opposite to each other.
